(19) United States
(12) Patent Application Publication
(10) Pub. No.: US 2012/0308860 A1
(43) Pub. Date: Dec. 6, 2012

(54) CASING FOR A MULTI-CELL ELECTROCHEMICAL BATTERY AND MULTI-CELL ELECTROCHEMICAL BATTERY INCORPORATING THE SAME

(76) Inventors: Carmine Pizzurro, Markham (CA); Emilio Carnale, Whitby (CA)

(21) Appl. No.: 13/395,755

(22) PCT Filed: Sep. 13, 2010
(86) PCT No.: PCT/CA2010/001408

§ 371 Date: Aug. 23, 2012

Related U.S. Application Data
(60) Provisional application No. 61/241,948, filed on Sep. 13, 2009.

(51) Int. Cl. H01M 10/52; H01M 2/02

(52) U.S. Cl. 429/89

(57) ABSTRACT

A multi-cell electrochemical battery comprises a casing having an interior divided into a plurality of battery cell compartments by at least one partition, each battery cell compartment sized to receive a plurality of battery cells. A fluid circuit comprises a plurality of flow passages extending across said container through said at least one partition. Fluid inlet structure receives input fluid and delivers the input fluid to the fluid circuit. Fluid outlet structure permits the egress of fluid exiting the fluid circuit from the container. A plurality of electrochemical battery cells is accommodated in each battery cell compartment.

### FIELD OF THE INVENTION

The present invention relates generally to electrochemical batteries and in particular, to a casing for a multi-cell electrochemical battery and to a multi-cell electrochemical battery incorporating the same.

### BACKGROUND OF THE INVENTION

Rechargeable, multi-cell electrochemical batteries are becoming increasingly popular and are used in a variety of commercial and industrial applications. Depending on the application, the number of electrochemical cells and the parallel and serial interconnections of the electrochemical cells in the electrochemical batteries vary to achieve the desired battery output voltages (determined by the series connections of the electrochemical cells) and the desired battery capacity and current handling capabilities (determined by the parallel connections of the electrochemical cells). Unfortunately however, electrochemical cells are expensive. As a result, to make the use of electrochemical batteries economic, it is necessary to take steps to prolong the operating life of the electrochemical cells.

One factor that has an impact on the operating life of electrochemical cells is temperature. In order to prolong the operating life of electrochemical cells, the temperature of the electrochemical cells must be controlled so that the temperature of the electrochemical cells stays within the specified operating range of the electrochemical cells. Operating the electrochemical cells outside of the specified temperature range can severely decrease the operating life of the electrochemical cells. It is therefore not surprising that techniques to provide cooling to multi-cell electrochemical batteries have been considered.

For example, U.S. Pat. No. 7,264,901 to Gow et al. discloses a monoblock battery case comprising a first container and a second container each having partitions that divide the containers into cell compartments. The first container is attached to and co-operates with the second container to form one or more coolant channels disposed between the facing surfaces of the first and second containers. Outer ribs defining fluid baffles may also be provided on the opposite surfaces of the first and second containers.

U.S. Pat. No. 7,547,487 to Smith et al. discloses a multi-cell battery in which a plurality of electrochemical cells are disposed in a battery case. The battery case includes one or more partitions which divide the interior of the case into a plurality of cell compartments that house the electrochemical cells. One or more of the partitions include coolant channels. The bottom of the casing includes ribs that define fluid baffles for fluid flow purposes. Coolant enters the bottom plate via an inlet opening adjacent one end of the bottom plate, travels along flow channels to defined by the ribs and through coolant channels in the partitions before exiting the bottom plate via an outlet opening adjacent the opposite end of the bottom plate.

Although cooling techniques for multi-cell electrochemical batteries exist, improvements are desired. It is therefore an object of the present invention to provide a novel casing for a multi-cell electrochemical battery and a novel multi-cell electrochemical battery incorporating the same.

### SUMMARY OF THE INVENTION

Accordingly, in one aspect there is provided a casing for a multi-cell battery comprising: a container comprising a bottom, opposite major sides and opposite minor sides, the interior of the container being divided into a plurality of battery cell compartments by at least one partition extending between the opposite major sides, each battery cell compartment sized to receive a plurality of battery cells; a fluid circuit comprising a plurality of flow passages extending through said at least one partition between the opposite major sides; fluid inlet structure to receive input fluid and deliver said input fluid to said fluid circuit; and fluid outlet structure to permit the egress of fluid exiting said fluid circuit from said container.

In one embodiment, the container is divided into a plurality of battery cell compartments by a plurality of spaced partitions. In this case, the fluid circuit comprises a plurality of spaced flow passages extending through each partition. The fluid circuit also comprises a plurality of spaced flow passages extending through each of the minor sides. The flow passages extending through each partition and each minor side are generally parallel and are generally evenly spaced.

In one embodiment, each battery cell compartment is sized to receive the same number of battery cells. In one embodiment, a plurality of fluid chambers is provided adjacent each major side of the container with each fluid chamber communicating with at least two sets of fluid passages. The fluid chambers and fluid passages are arranged so that fluid delivered to the fluid inlet structure initially flows through the flow passages in one of the minor sides, then through each partition in succession via the flow passages therein and then through the flow passages in the other of the minor sides before exiting the container via the fluid outlet structure.

According to another aspect there is provided a multi-cell to electrochemical battery comprising: a casing having an interior divided into a plurality of battery cell compartments by at least one partition; a fluid circuit comprising a plurality of flow passages extending across said container through said at least one partition; fluid inlet structure to receive input fluid and deliver said input fluid to said fluid circuit; fluid outlet structure to permit the egress of fluid exiting said fluid circuit from said container; and a plurality of electrochemical battery cells accommodated in each battery cell compartment.

### BRIEF DESCRIPTION OF THE DRAWINGS

Embodiments will now be described more fully with reference to the accompanying drawings in which:

FIG. 1 is a perspective view taken from above and from the side of a multi-cell electrochemical battery;

FIG. 2 is a front view of the multi-cell electrochemical battery of FIG. 1;

FIG. 3 is a side view of the multi-cell electrochemical battery of FIG. 1;

FIG. 4 is a top plan view of the multi-cell electrochemical battery of FIG. 1;

FIG. 5 is a perspective view taken from above and from the side of a main casing forming part of the multi-cell electrochemical battery of FIG. 1;

FIG. 6 is a front cross-sectional view of the multi-cell electrochemical battery of FIG. 1;

FIG. 7 is a perspective view of an electrochemical cell forming part of the multi-cell electrochemical battery of FIG. 1;

FIGS. 8a and 8b are perspective views of side panels forming part of the multi-cell electrochemical battery of FIG. 1;

FIGS. 9a and 9b are perspective cross-sectional views of the multi-cell electrochemical battery of FIG. 1;

FIG. 10 is a perspective view of the multi-cell electrochemical battery of FIG. 1 with its cover panel made transparent to expose the top panel of the multi-cell electrochemical battery;

FIG. 11 is an exploded perspective view of a portion of the multi-cell electrochemical battery of FIG. 1;

FIG. 12 is a perspective view of the multi-cell electrochemical battery of FIG. 1 with the cover panel made transparent to expose a battery management system (BMS) disposed on the top panel; and

FIG. 13 is a perspective cross-sectional view of the multi-cell electrochemical battery of FIG. 1 showing fluid flow therethrough.

### DETAILED DESCRIPTION OF THE EMBODIMENTS

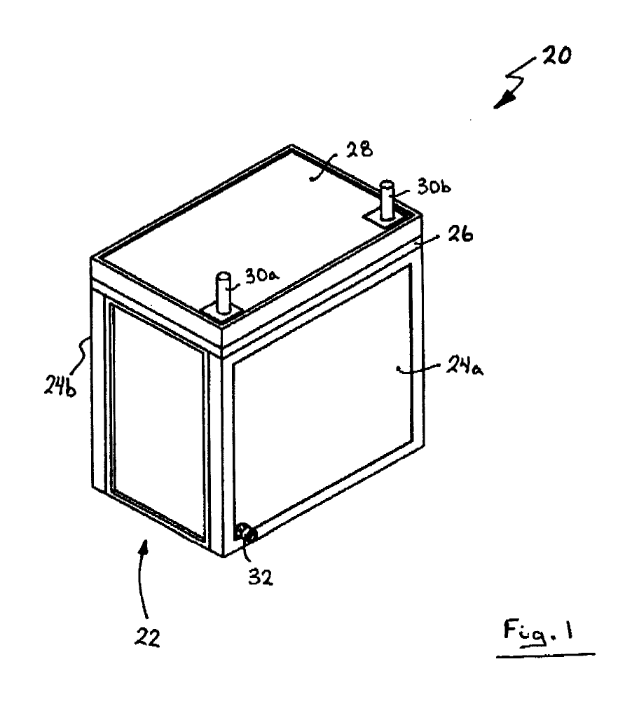

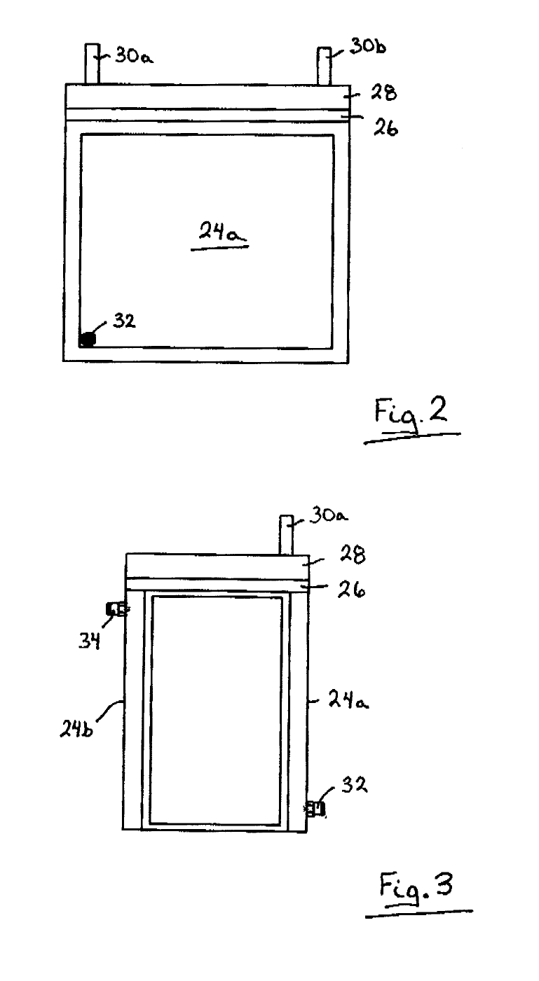

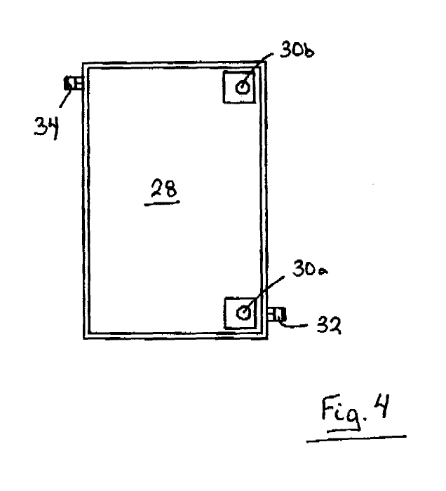

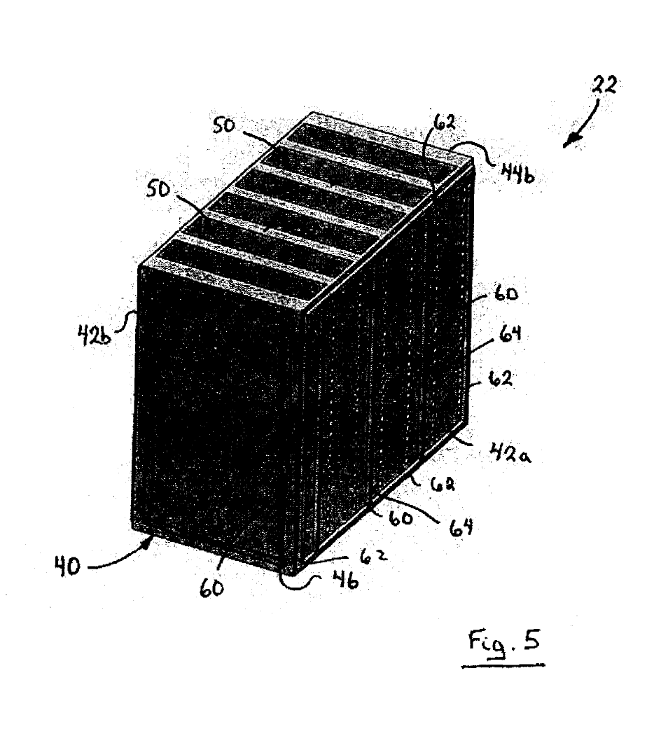

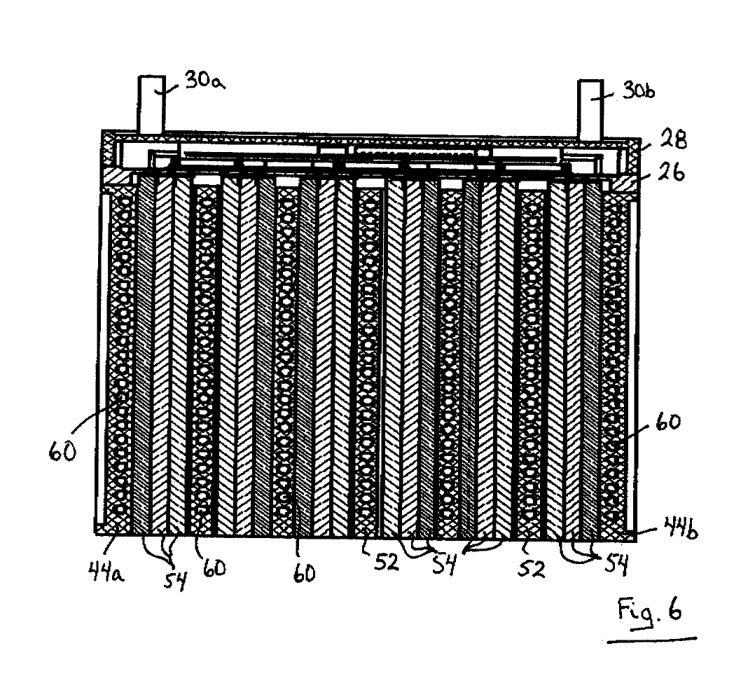

Turning now to FIGS. 1 to 4, a multi-cell electrochemical battery is shown and is generally identified by reference numeral 20. Multi-cell electrochemical battery 20 is suitable for use in a variety of commercial and industrial applications including but not limited to energy storage applications and vehicular applications (e.g. motorized wheelchairs, scooters, motorcycles, snowmobiles, personal watercraft, all terrain vehicles (ATVs), automobiles, trucks, busses, construction equipment) etc. Multi-cell electrochemical battery 20 comprises a rectangular main casing 22 comprising side panels 24a and 24b secured to opposite major sides of a generally rectangular container 40 (see FIG. 5), a top panel 26 secured to and overlying the container 40 and a cover panel 28 secured to and overlying the top panel 26. The container 40, side panels 24a, 24b, top panel 26 and cover panel 28 are formed of non-conductive, molded lightweight, biodegradable plastic material and are secured together using adhesive, melting, ultrasonic welding or other suitable technique. Negative and positive conductive terminals 30a and 30b, respectively, extend upwardly from the cover panel 28 at laterally spaced locations. A fluid inlet 32 is provided in side panel 24a adjacent its bottom left corner and a fluid outlet 24 is provided in side panel 24b adjacent its top right corner. The fluid inlet 32 and fluid outlet 34 communicate with a fluid circuit within the multi-cell electrochemical battery 20 to enable the temperature of the multi-cell electrochemical battery 20 to be controlled as will be described.

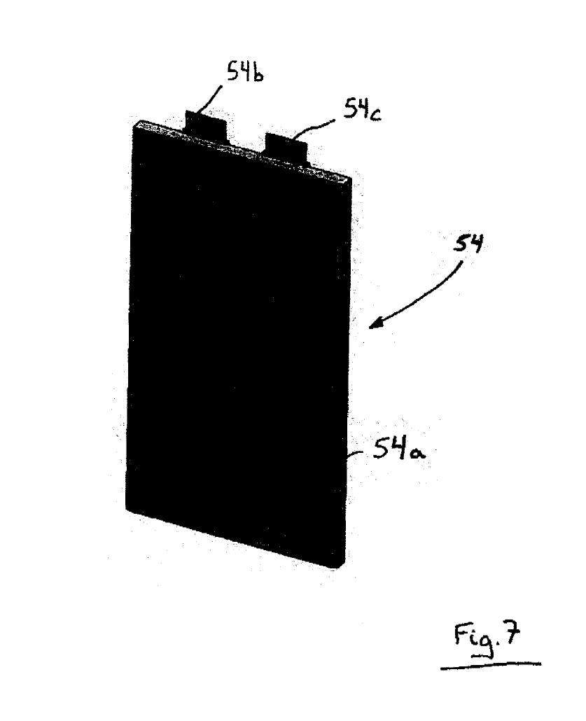

FIG. 5 better illustrates the container 40. As can be seen, the container 40 is of a unitary construction and has opposite major sides 42a and 42b, opposite minor sides 44a and 44b and a bottom 46. Side panel 24a is secured to major side 42a and side panel 24b is secured to major side 42b. The interior of the container 40 is divided into a plurality of cell compartments 50, in this example six (6) cell compartments, by partitions or webs 52. In this embodiment, each cell compartment 50 is sized to receive a group of electrochemical cells 54 comprising three (3) electrochemical cells as shown in FIG. 6. A plurality of vertically spaced, generally parallel fluid passages 60 extends across the container 40 through each of the webs 52 as well as through each of the minor sides 44a and 44b. The fluid passages 60 are generally equally spaced and have a diameter equal to approximately five (5) millimeters.

A flange 62 extends about the perimeter of each major side 42a, 42b and is slightly inwardly spaced from the outer peripheral edges of the major side. A plurality of laterally spaced, vertical ribs 64, in this example three (3) ribs, is formed on each major side 42a, 42b. The ribs 64 formed on major side 42a are offset from the ribs formed on major side 42b.

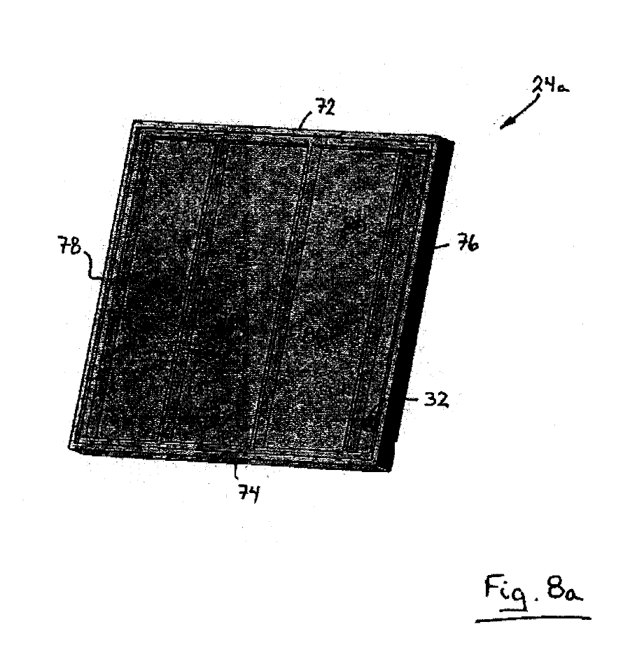

FIG. 7 better illustrates one of the electrochemical cells 54. As can be seen, in this embodiment, each electrochemical cell 54 is a lithium ion battery cell such as that manufactured by Kokam Co. Ltd. of South Korea. The electrochemical cell 54 has a generally rectangular body Ma and positive and negative terminal tabs 54b and 54c, respectively, extending upwardly from the top of the body 54a.

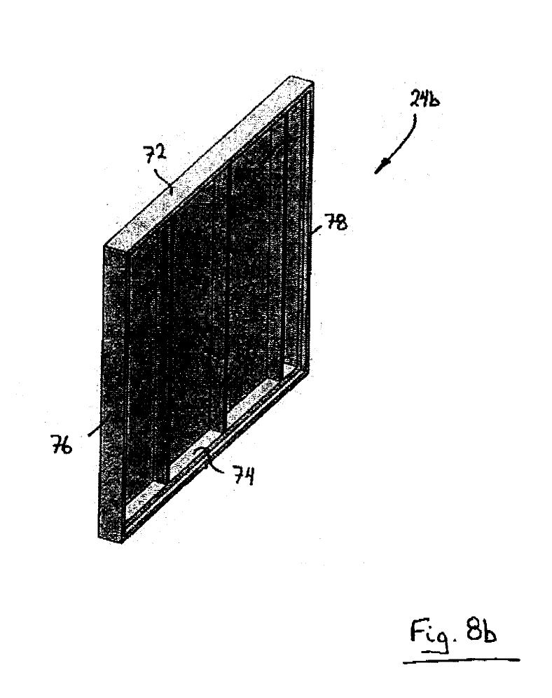

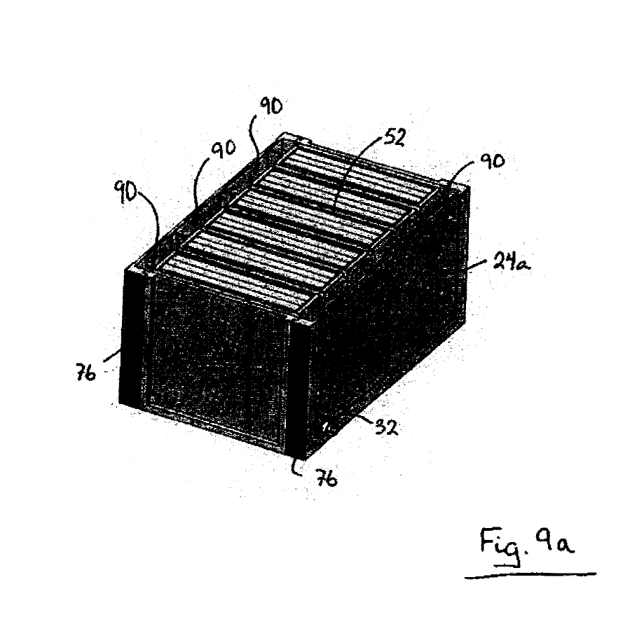

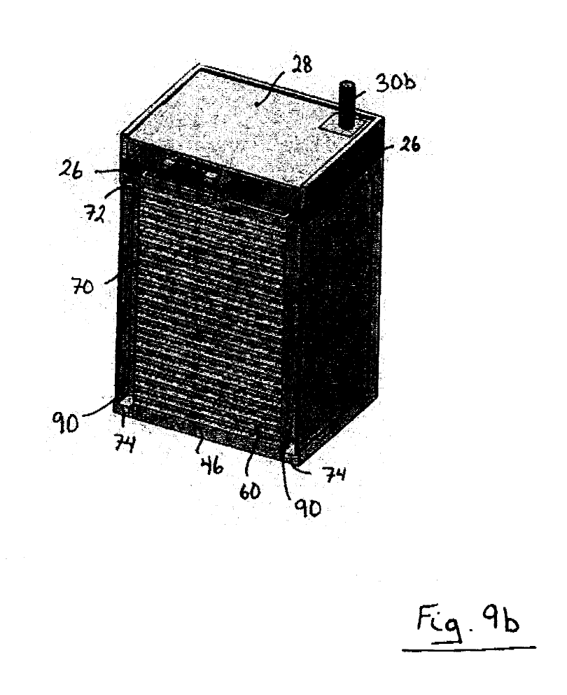

FIGS. 8a and 8b better illustrate the side panels 24a and 24b. As can be seen, each side panel 24a, 24b has a major outer wall 70, top and bottom walls 72 and 74 and opposite side walls 76 and 78. Vertical ribs 80 extend between the top and bottom walls 72 and 74 at laterally spaced locations intermediate the side walls 76 and 78. For each side panel 24a, 24b, the peripheral edges of the top, bottom and opposite side walls are notched to take a configuration that is complimentary to the peripheral flange 62 extending about its associated major side 24. The vertical ribs 80 are also in alignment with the vertical ribs 64. In this manner, with the side panels 24a, 24b secured to the main casing 22, the abutting ribs 80 and 64 divide the space between each side of the container 40 and its associated side panel into a plurality of isolated fluid chambers 90 as best shown in FIGS. 9a and 9b.

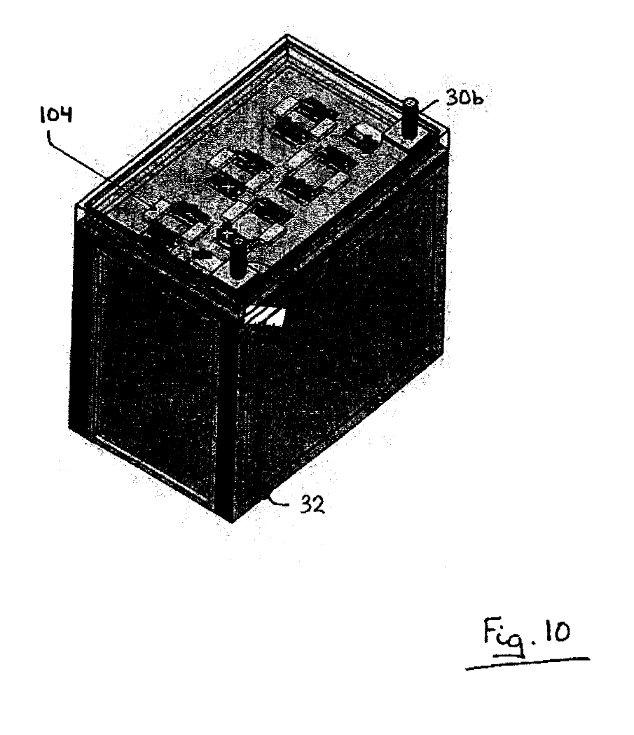

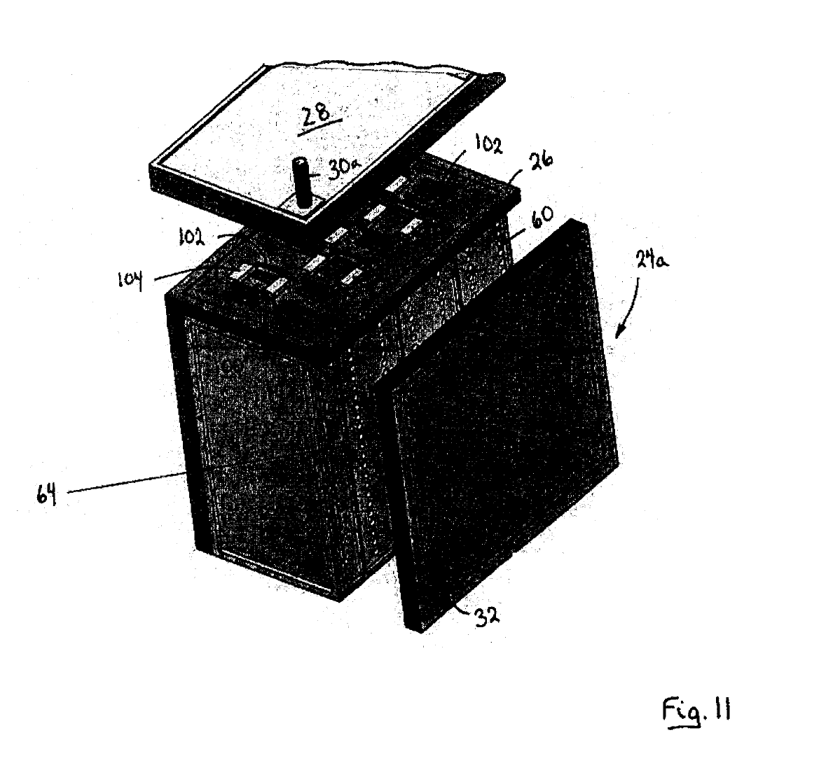

For each cell compartment 50, the electrochemical cells 54 are placed in the cell compartment in the same orientation. In this manner, the positive terminal to tabs 54b of the electrochemical cells 54 and the negative terminal tabs 54c of the electrochemical cells 54 in each cell compartment 50 are positioned adjacent opposite ends of the cell compartment. The orientation of the electrochemical cells 54 in successive cell compartments 50 is also reversed so that the polarities of the tabs adjacent the ends of the cell compartments 50 alternate along the multi-cell electrochemical battery 20 as shown in FIG. 10.

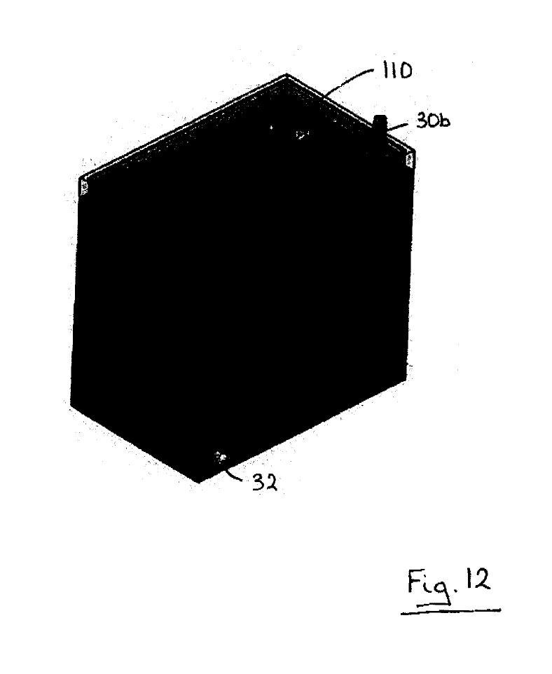

The terminal tabs of the electrochemical cells 54 adjacent the ends of the cell compartments 50 pass through openings 100 in the top panel 26 as best shown in FIG. 11. Connectors 102 interconnect the adjacent terminal tabs of the electrochemical cells 54 in each cell compartment 50 thereby to connect the three electrochemical cells 54 in each cell compartment 50 electrically in parallel. The connectors 102 can be mechanically fastened to the terminal tabs or welded to the terminal tabs. Connectors 104 are also provided on the top panel 26 and extend between adjacent connectors 102 thereby to connect the groups of electrochemical cells 54 in the cell compartments 50 electrically in series. Similarly, connectors 104 can be mechanically fastened to the connectors 102 or welded to the connectors.

A battery management system (BMS) 110 overlies the top panel 26 and is electrically connected to the connectors 104 as shown in FIG. 12. Battery management system 110 may be of any known type such as for example those sold by Analog Devices Inc. of Norwood, Mass. or Elithion of Boulder, Colo. As is known to those of skill in the art, the battery management system 110 monitors the temperature and voltage of each group of electrochemical cells 54, monitors the current output of the multi-cell electrochemical battery 20, defects abnormal battery operating conditions, protects against over/under voltage, current and/or temperature conditions etc.

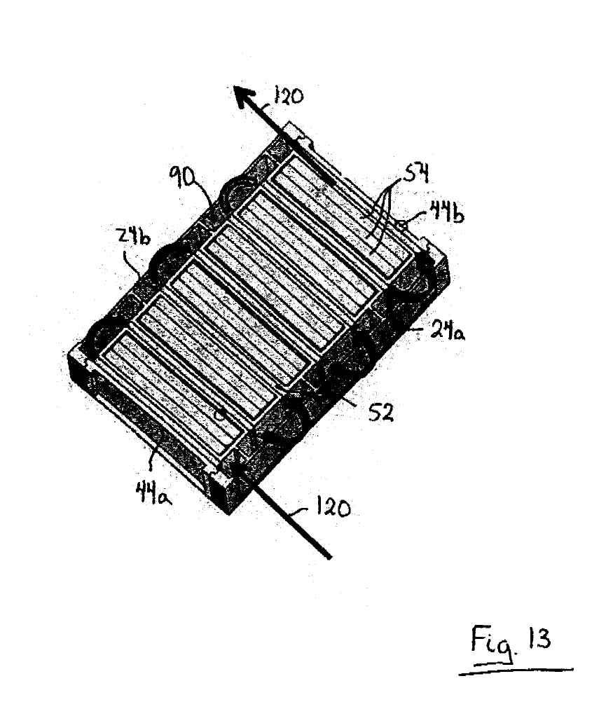

As mentioned above, controlling the temperature of the electrochemical cells 54 so that the temperature of the electrochemical cells remains within the specified operating temperature range is desired to prolong the operating life of the electrochemical cells. In particular, when it is desired to cool the multi-cell electrochemical battery 20, cooled fluid (e.g. cooled gas or liquid) from a heat exchanger or other suitable source (e.g. the air conditioning unit of an automobile) is delivered to the fluid inlet 32. The cooled fluid received by the fluid inlet 32 enters the multi-cell electrochemical battery 20, fills the fluid chamber 90 adjacent the fluid inlet 32 and flows through the fluid passages 60 in the minor side 44a. Fluid exiting the fluid passages 60 in the minor side 44a fills the fluid chamber 90 on the opposite side of the multi-cell electrochemical battery 20 and flows back through the flow passages 60 in the web 52 adjacent the minor side 44a. Fluid exiting the flow passages 60 of the web 52 adjacent the minor side 44a fills the associated fluid chamber 90 and flows through the fluid passages 60 in the next web 52. This back and forth fluid flow across the main casing 22 continues until the fluid exits the flow passages 60 in the minor side 44b, fills the associated fluid chamber 90 and exits the multi-cell electrochemical battery 20 via the fluid outlet 34. Cooled fluid therefore circulates back and forth across the multi-cell electrochemical battery 20 as shown by arrow 120 in FIG. 13 thereby cooling the minor sides 44a, 44b and the webs 52, which are in contact with the major surfaces of the outer electrochemical cells 54 in the cell compartments 50. As a result, suitable cooling is provided to the electrochemical cells 54 to ensure the temperature of the electrochemical cells 54 remains within the specified operating range. Should the electrochemical cells 54 require heating to bring the electrochemical cells 54 up to operating temperature in cold climates, heated fluid rather than cooled fluid can be delivered to the fluid inlet 32.

As will be appreciated, the casing for the multi-cell electrochemical battery 20 is modular making it easy to manufacture and easy to assembly. Although the cell compartments 50 are shown as accommodating three electrochemical cells 54, the cell compartments can be configured to hold fewer or more than three electrochemical cells. When the cell compartments 50 are configured to hold more than three electrochemical cells, care should be taken to ensure that adequate heat exchange between the outer and inner electrochemical cells in the cell compartments occurs so that the desired electrochemical cell cooling or heating results. Depending on the application, the multi-cell electrochemical battery 20 may include fewer or more cell compartments 50 than described above and illustrated.

The positions of the fluid inlet 32 and the fluid outlet 34 on the side panels 24a and 24b are exemplary. Other suitable fluid inlet and fluid outlet positions can be utilized. If desired, multiple fluid inlets and multiple fluid inlets may also be utilized. Alternatively, the side panels 24a and 24b may be configured as manifolds. For example, side panel 24a may comprise a single fluid inlet and have internal flow passages formed in the outer major wall 70 that deliver input fluid to the fluid chambers 90 in parallel. Side panel 24b in this case similarly has internal flow passages formed in the outer major wall that receive fluid from the fluid chambers 90 that has exited the flow passages 60 and that deliver the received fluid to a single fluid outlet.

Rather than using connectors 102 and 104 that are mechanically fastened or welded to the terminal tabs and to each other, conductive adhesive can be used to connect the electrochemical cells in each cell compartment electrically in parallel and to connect the groups of electrochemical cells in the cell compartments electrically in series.

Although embodiments have been described with reference to the drawings, those of skill in the art will appreciate that variations and modifications may be made without departing from the spirit and scope thereof as defined by the appended claims.

1. A casing for a multi-cell battery comprising:
a container comprising a bottom, opposite major sides and opposite minor sides, the interior of the container being divided into a plurality of battery cell compartments by at least one partition extending between the opposite major sides, each battery cell compartment sized to receive a plurality of battery cells;
a fluid circuit comprising a plurality of flow passages extending through said at least one partition between the opposite major sides;
fluid inlet structure to receive input fluid and deliver said input fluid to said fluid circuit; and
fluid outlet structure to permit the egress of fluid exiting said fluid circuit from said container.

2. A casing according to claim 1 wherein said container is divided into a plurality of battery cell compartments by a plurality of spaced partitions and wherein said fluid circuit comprises a plurality of spaced flow passages extending through each said partition.

3. A casing according to claim 2 wherein said fluid circuit comprises a plurality of spaced flow passages extending through each of said minor sides.

4. A casing according to claim 3 wherein the flow passages extending through each said partition and each said minor side are generally parallel.

5. A casing according to claim 3 wherein the flow passages extending through each said partition and each said minor side are generally evenly spaced.

6. A casing according to claim 1 wherein each battery cell compartment is sized to receive the same number of battery cells.

7. A casing according to claim 6 wherein each battery cell compartment is sized to receive at least three (3) electrochemical cells.

8. A casing according to claim 1 further comprising at least one fluid chamber adjacent each major side of said container, the fluid chambers communicating with said fluid passages.

9. A casing according to claim 3 comprising a plurality of fluid chambers adjacent each major side of said container, each fluid chamber communicating with at least two sets of fluid passages.

10. A casing according to claim 9 wherein said fluid chambers and fluid passages are arranged so that fluid delivered to said fluid inlet structure flows back and forth across said container via the fluid passages in the minor sides and the partitions before exiting the container via the fluid outlet structure.

11. A casing according to claim 10 wherein fluid delivered to said fluid inlet structure initially flows through the flow passages in one of the minor sides, then through each partition in succession via the flow passages therein and then through the flow passages in the other of the minor sides before exiting the container via the fluid outlet structure.

12. A casing according to claim 9 further comprising side panels secured to said opposite major sides, the space between each side panel and its associated major side being partitioned to define said fluid chambers.

13. A casing according to claim 12 wherein each space is partitioned by aligned ribs formed on said side panel and associated major side.

14. A casing according to claim 1 further comprising a top panel overlying and secured to said container.

15. A multi-cell electrochemical battery comprising:
a casing having an interior divided into a plurality of battery cell compartments by at least one partition;
a fluid circuit comprising a plurality of flow passages extending across said container through said at least one partition;
fluid inlet structure to receive input fluid and deliver said input fluid to said fluid circuit;
fluid outlet structure to permit the egress of fluid exiting said fluid circuit from said container; and
a plurality of electrochemical battery cells accommodated in each battery cell compartment.

16. A multi-cell electrochemical battery according to claim 15 wherein said casing is divided into a plurality of battery cell compartments by a plurality of spaced partitions and wherein said fluid circuit comprises a plurality of spaced flow passages extending through each said partition.

17. A multi-cell electrochemical battery according to claim 16 wherein the flow passages extending through each said partition are generally parallel.

18. A multi-cell electrochemical battery according to claim 16 wherein the flow passages extending through each said partition are generally evenly spaced.

19. A multi-cell electrochemical battery according to claim 15, wherein flow passages also extend through opposite sides of said casing that are parallel to said partitions.

20. A multi-cell electrochemical battery according to claim 15 wherein each battery cell compartment accommodates the same number of electrochemical battery cells.

21. A multi-cell electrochemical battery according to claim 20 wherein each battery cell compartment accommodates at least three (3) electrochemical battery cells.

22. A multi-cell electrochemical battery according to claim 15 further comprising at least one fluid chamber adjacent each opposite major side of said casing, the fluid chambers communicating with said fluid passages.

23. A multi-cell electrochemical battery according to claim 19 comprising a plurality of fluid chambers adjacent each major side of said casing, each fluid chamber communicating with at least two sets of fluid passages.

24. A multi-cell electrochemical battery according to claim 23 wherein said fluid chambers and fluid passages are arranged so that fluid delivered to said fluid inlet structure flows back and forth across said casing via the fluid passages in the minor sides and the partitions before exiting the casing via the fluid outlet structure.

25. A multi-cell electrochemical battery according to claim 24 wherein fluid delivered to said fluid inlet structure initially flows through the flow passages in one of the sides, then through each partition in succession via the flow passages therein and then through the flow passages in the other of the sides before exiting the casing via the fluid outlet structure.

26. A multi-cell electrochemical battery according to claim 15 wherein said casing comprises a top panel having openings therein through which terminals of said electrochemical battery cells pass.

27. A multi-cell electrochemical battery according to claim 26 further comprising connectors to connect the electrochemical battery cells in each battery cell compartment electrically in parallel and connectors to connect the electrochemical cells in different battery cell compartments electrically in series.

28. A multi-cell electrochemical battery according to claim 27 further comprising a battery management system overlying the top panel and electrically connected to said connectors.
